(19) United States
(12) Patent Application Publication
(10) Pub. No.: US 2018/0219966 A1
(43) Pub. Date: Aug. 2, 2018

(54) METHOD FOR ESTABLISHING OTA SESSIONS BETWEEN TERMINALS AND AN OTA SERVER, CORRESPONDING OTA SERVER AND REVERSE PROXY SERVER

(71) Applicant: GEMALTO SA, Meudon (FR)

(72) Inventors: Xavier BERARD, GEMENOS Cedex (FR); Patrice AMIEL, GEMENOS Cedex (FR); Ludovic TRESSOL, GEMENOS Cedex (FR); Gregory VALLES, GEMENOS Cedex (FR)

(73) Assignee: GEMALTO SA, Meudon (FR)

(21) Appl. No.: 15/503,312

(22) PCT Filed: Aug. 5, 2015
(86) PCT No.: PCT/EP2015/068034

§ 371 Date: Feb. 10, 2017

(30) Foreign Application Priority Data
Aug. 13, 2014 (EP) 14306272.7

(51) Int. Cl. H04L 29/08; H04L 29/06

(52) U.S. Cl. CPC H04L 67/2895; H04L 63/0876; H04L 63/20; H04L 67/141

(57) ABSTRACT

A method for establishing OTA sessions between terminals and an OTA server in a telecommunications network, each of the terminals interacting with a security element capable of interrogating the OTA server to establish a secure session in order to download data from the OTA server via a reverse proxy server in order to update security elements. The method includes provision by an OTA server to reverse proxy server of a list of identifiers of security elements for which an update is available; only establishing a secure session between the security elements and the OTA server for the security elements having identifiers included in said list.

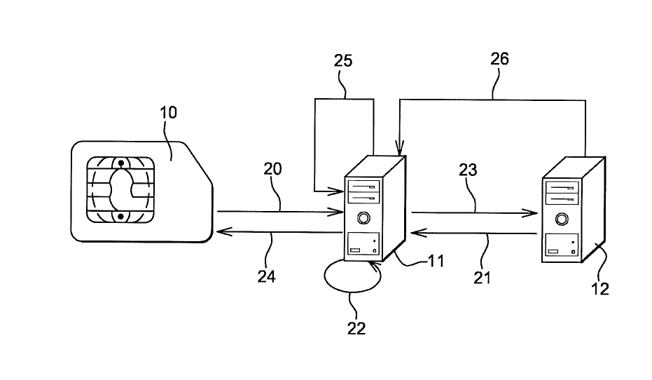

The present invention relates to the field of telecommunications and more specifically that of remote administration of security elements such as UICCs (Universal Integrated Circuit Cards) interacting with terminals, for example portable terminals such as telephones, smartphones, PDAs or computers. The security elements may also be in the form of circuits integrated in machines, such as in the field of M2M (Machine to Machine). They are not necessarily physically connected to the terminals, but can communicate with the latter through a short range connection, wherein a security element is offset and communicates with the terminal via a short range channel (Bluetooth or WiFi, for instance).

Such security elements administration is conventionally provided via OTA (Over The Air) in order to update or install data or programs in/into the security elements. This kind of administration uses the http protocol and is also called ‘RFM’ (Remote File Management) or ‘RAM’ (Remote Administration Management) via http (HyperText Transfer Protocol).

Security elements can be administered in two ways:
The first one consists in transmitting, from an OTA platform, data or programs to targeted security elements, for example in the course of updating campaigns. This type of administration is called “push” and is based on the transmission in SMS mode. The problem lies in that this method is not suitable for new generation networks such as LTE networks which do not support the SMS (they are fully http). In addition, the RAM or RFM type administrations via http have been developed to avoid unreliable protocols such as SMS.
The second one consists in interrogating, for example regularly or upon the occurrence of an event, the OTA platform in order to know whether updates are available or not. Such interrogation is initiated by the security element and is called “polling” or “pull” (the security element checks out whether the platform has something to transmit it). The interrogation is carried out in http mode.

The problem with this solution is that, in general, the security element does not wait for the occurrence of an event to interrogate the OTA platform. “Polling” is thus carried out regularly, for instance every two weeks or monthly. And most of the time, the OTA platform has nothing to transmit to the security element . . . . The applicant for example noted that, in 90% of the interrogations of the OTA by the security elements in the field, no update or program or data is to be transmitted to the security element. This results in unnecessary microwave traffic and in the overloading of the OTA platform (a TLS-PSK link is established between the security element and the OTA platform upon each interrogation of the security element). Besides, when the internal network of a data center is involved in updating security elements (for instance the data center of a manufacturer of security elements with which the mobile phone operator has trusted its services), the network will also be interrogated needlessly. In addition, when the network uses physically decentralized servers, additional communications have to be added.

To overcome this drawback of the second mode of operation, two solutions are possible:
extending the time between two interrogations “polling” of the OTA platform (an application in the security element is updated to extend this time). A drawback exists in that, if updates are available just after the last interrogation, the security element will be updated much later only.
switching to the “push” mode. The aforementioned problems then reappear.

It can thus be noted that a regular interrogation of an OTA platform by the security elements is not at all satisfactory and has a very negative impact specially on the OTA platform which is permanently requested to assess http requests that lead to no update of such security elements and generates unnecessary traffic.

The present invention is intended to remedy such drawbacks.

Specifically, one object of the invention is to avoid unnecessary data traffic between a security element “polling” (interrogating) a server or an OTA platform to know whether this platform has data to transmit it (the term “data” should be understood here in its broadest sense, it may be the transmission of a program, subscription data (IMSI/Ki for a new subscription with the security fields and the corresponding keys) or simple updates of data or programs. This unnecessary data traffic mainly results from the establishment of TLS-PSK sessions between the “polling” security elements and the OTA platform.

This object, as well as others which will appear later, is achieved through a process of establishing OTA sessions between terminals and an OTA server in a telecommunications network, with the terminals each interacting with a security element capable of interrogating the OTA server in order to establish a secure session in order to download data from the OTA server via a reverse proxy server in order to update the security elements, with such method comprising:
provision by an OTA server to the reverse proxy server of a list of identifiers of the security elements for which an update is available;
establishing a secure session between the security elements and the OTA server for the security elements having identifiers included in said list only.

Advantageously, the method consists in removing the identifier of a security element from the list once the security element has been updated.

The identifier is preferably a PSK-ID and the secure session is a TLS-PSK session.

In one advantageous embodiment, the OTA server also provides the reverse proxy server with its charge level.

The invention also relates to an OTA server intended for updating security elements interacting with terminals in a telecommunications network, with the security elements each being capable of interrogating the OTA server for establishing a secure session in order to download data from the OTA server via a reverse proxy server in order to update the security elements, with such OTA server comprising means for providing the reverse proxy server with a list of identifiers of the security elements for which an update is available.

Advantageously, the OTA server comprises means for providing the reverse proxy server with its charge level.

The invention also relates to a reverse proxy server on a telecommunications network, with the reverse proxy server interacting, on the one hand, with terminals interacting with the security elements and on the other hand, with an OTA server capable of updating the security elements upon request from said security elements via the reverse proxy server, with such proxy server comprising a list of the identifiers of the security elements for which an update is available, with the list being updated by the OTA server, with the reverse proxy server comprising means for authorizing the establishment of secure sessions between the OTA server and the security elements, the identifiers of which are included in the list and means for preventing the establishment of secure sessions between the OTA server and the security elements, the identifiers of which are not included in the list.

This list is preferably updated by the OTA server.

Other characteristics and advantages of the present invention will appear upon reading the following description of a preferred embodiment given by way of illustration and not restriction, and the appended single FIGURE showing the essential steps of the invention.

This FIGURE shows three elements:
a security element 10;
a reverse proxy server 11;
an OTA server 12.

The security element 10, shown as a SIM or UICC card here, interacts with a terminal, for example a smartphone, not shown. In “pull” mode, this security element 10 decides, typically on a time basis (for instance fifteen days) to interrogate the OTA server 12 (an application server) to know whether it has data to transmit it.

Such interrogation conventionally involves a reverse proxy server 11 which, in the prior art, is used for establishing the TLS-PSK link between the security element 10 and the OTA server 12.

The invention proposes to use such reverse proxy server 11 as a filter between the security element 10 and the OTA server 12. The filter function results in a secure session between the security element 10 and 12 OTA server not being established if the later has no data to transmit it.

More specifically, the method according to the invention operates as follows:

During a step 20, the security element 10 initiates a “polling” request with the OTA server 12. This request reaches, as in the state of the art, the reverse proxy server 11.

According to the invention, the reverse proxy server 11 previously received a list or an update of a list of security elements 10 authorized to connect to the OTA server 12 from the OTA server 12, during a step 21. Such list typically comprises the identifiers, preferably the PSK-IDs or ICCIDs, of the security elements 10 for which updates (data in the broadest sense) are available at the OTA server 12. The reverse proxy server 11 thus knows the security elements 10 for which an update is available.

During a step 22, the reverse proxy server 11 checks out whether the security element 10 which initiated the step of “polling” 20, thanks to the received identifier, whether the latter is eligible for an update. If the received identifier matches that of a security element 10 for which update data is available, the reverse proxy server 11 transmits, during a step 23, information to the OTA server 12, informing it that the security element 10 is capable of receiving data from the OTA server 12, and a secure session, preferably a TLS-PSK session, is established between the security element 10 and the OTA server 12 via the reverse proxy server 11. The data to be transmitted from the OTA platform 12 to the security element 10 is then transmitted on a secure channel. Upon completion of the session, the channel is closed.

On the contrary, if the identifier received by the reverse proxy server 11 does not match that of a security element 10 for which update data is available, the reverse proxy server 11 transmits to the security element 10, during a step 24, information informing it that there is no data to be transmitted from the OTA server 12 and no secure session is established between the security element 10 and the OTA server 12.

During a step 25, once an update of the data has been performed on a security element 10, the reverse proxy server refreshes its list 11 in order to remove therefrom the identifier of the security element 10 which has just been updated. This operation can also be executed during the step 21 mentioned above (refreshing the list of security elements to be updated).

Using a PSK-ID as a filter criterion at the reverse proxy 11 has two advantages:
the filtering of the reverse proxy 11 is executed prior to any establishment of a TLS-PSK session;
the PSK-ID is very representative of the entity (the security element 10) for which an action has to be taken since it includes the security field for which services are to be executed in the OTA server 12.

An optional step 26 consists in informing the reverse proxy server 11 of its state of charge. If the state of charge is too high, the reverse proxy server 11 systematically prohibits any secure link between the OTA server 12 and a security element 10 inquiring about the availability of data to be updated or redirects the request from the security element to a server which is capable of handling such update request.

The present invention also relates to the OTA server 12 intended for updating the security elements interacting with terminals in a telecommunications network, with the security elements 10 each being capable of interrogating the OTA server 12 in order to establish a secure session to download data from the OTA server 12 via the reverse proxy server 11 in order to update the security elements 10, with the OTA server 12 comprising means to provide the reverse proxy server with a list of the identifiers of the security elements 10 for which an update is available.

The OTA server 12 also comprises means for providing the reverse proxy server 11 with its charge level.

The invention also relates to the reverse proxy server 11 interacting, on the one hand, with terminals interacting with the security elements 10 and on the other hand, with an OTA server 12 capable of updating the security elements 10 upon request therefrom via the reverse proxy server 11, with such reverse proxy server 11 comprising a list of the identifiers of the security elements 10 for which an update is available, with the list being updated by the OTA server (step 21), with the reverse proxy server 11 comprising means for authorizing the establishment of secure sessions between the OTA server 12 and the security elements 10, the identifiers of which are included in the list and means for preventing the establishment of secure sessions between the OTA server 12 and the security elements 10, the identifiers of which are not included in the list.

The invention therefore consists in filtering, upstream of the OTA server 12, in the reverse proxy server 11, the security elements which do not have to be updated. This makes it possible not to overload the operation of the OTA server 12 and not to generate unnecessary traffic. The reverse proxy server 11 rejects, upstream, the requests from the security elements 10 which do not have to be updated, prior to any establishment of a TLS-PSK link. This makes it possible to reduce the workload of the OTA server 12 and of the data centers which are connected to the operator's network by 90%.

Each time a new application has to be installed or modified at security elements 10, the application server or the OTA server 12 updates the list of the identifiers of the concerned security elements 10 at the reverse proxy server 11.

A filtering policy based on priorities (important updates for example), periods of validity of applications (which will then have priority relative to other applications or updates) or periods of expiry of validity of applications which will also have priority and updated in the list provided to the reverse proxy server 11 with their identifiers may also be provided for.

1. A method for establishing OTA sessions between terminals and an OTA server in a telecommunications network, with each of the terminals interacting with a security element capable of interrogating the OTA server to establish a secure session in order to download data from the OTA server via a reverse proxy server in order to update the security elements, comprising:
provision by an OTA server to the reverse proxy server of a list of identifiers of the security elements for which an update is available;
establishing a secure session between the security elements and the OTA server for the security elements having identifiers included in said list only.

2. A method according to claim 1, further comprising removing the identifier of a security element from the list once the security element has been updated.

3. A method according to claim 1, wherein the identifier is a PSK-ID.

4. A method according to claim 1, wherein the secure session is a TLS-PSK session.

5. A method according to claim 1, wherein the OTA server also provides its charge level to the reverse proxy server.

6. An OTA server intended for updating the security elements interacting with terminals in a telecommunications network, with the security elements each being capable of interrogating the OTA server for establishing a secure session in order to download data from the OTA server via a reverse proxy server in order to update the security elements, wherein it comprises means for providing the reverse proxy server with a list of identifiers of the security elements for which an update is available.

7. An OTA server according to claim 6, wherein it comprises means for providing the reverse proxy server with its charge level.

8. A reverse proxy server in a telecommunications network, with the reverse proxy server interacting, on the one hand, with terminals interacting with security elements and on the other hand, with an OTA server capable of updating the security elements upon request from said security elements via the reverse proxy server, wherein it comprises a list of identifiers of the security elements for which an update is available, with the list being updated by the OTA server, with the reverse proxy server comprising means for authorizing the establishment of secure sessions between the OTA server and the security elements, the identifiers of which are included in the list and means for preventing the establishment of secure sessions between the OTA server and the security elements, the identifiers of which are not included in the list.

9. A reverse proxy server according to claim 8, wherein the list is updated by the OTA server.
